(19) United States
(12) Patent Application Publication
(10) Pub. No.: US 2015/0211232 A1
(43) Pub. Date: Jul. 30, 2015

(54) CLIP FOR JOINING REINFORCED MEMBERS FOR USE IN REINFORCED CONCRETE SLABS AND/OR COLUMNS

(71) Applicant: Bradford G. BARUH, Hillsborough, CA (US)

(72) Inventor: Bradford G. BARUH, Hillsborough, CA (US)

(21) Appl. No.: 14/677,234

(22) Filed: Apr. 2, 2015

Related U.S. Application Data
(63) Continuation of application No. PCT/US2013/063615, filed on Oct. 7, 2013.
(60) Provisional application No. 61/710,319, filed on Oct. 5, 2012.
(60) Provisional application No. 61/788,223, filed on Mar. 15, 2013.

(51) Int. Cl. E04C 5/16; B21D 22/02; B21D 11/12; F16B 7/04

(52) U.S. Cl. CPC E04C 5/167; F16B 7/044; B21D 22/02; B21D 11/12

(57) ABSTRACT

A clip is disclosed for joining reinforcing members, which includes a first portion having a curvature thereto and adapted to wrap around a lower surface of a first reinforcing member; a second portion having a curvature thereto and adapted to exert a force against a side surface of a second reinforcing member, the second reinforcing member residing perpendicular to the first reinforcing member; and a mid-portion, which connects the first portion pair of legs to the second pair of legs.

### RELATED APPLICATION(S)

This application is a continuation of International Application No. PCT/US2013/063615 filed on Oct. 7, 2013, and claims priority under 35 U.S.C. §119 to U.S. Provisional Patent Application No. 61/710,319, filed on Oct. 5, 2012, and U.S. Provisional patent Application No. 61/788,223, filed on Mar. 15, 2013, the entire contents of which are hereby incorporated herein by reference in their entireties.

### FIELD OF THE INVENTION

This invention generally relates to a system and method of joining reinforcing members for use in concrete slabs and/or columns, and more particularly, a clip for joining reinforcing members for use in reinforced concrete slabs and/or columns.

### BACKGROUND

In the manufacture of reinforced concrete structures, such as concrete pipes or columns, walls, slabs, and the like, it is important that the steel reinforcement, typically in the form of welded-wire mesh, be properly positioned in the cross section of the designed structure. Improper positioning of the reinforcement degrades the structural integrity of the unit and, in a severe case, can lead to structural failure. Moreover, as labor skill and costs are significant factors in the manufacture of reinforced concrete structures, it is also important that the positioning of the reinforcement be carried out in an accurate, and as simple and straightforward manner as possible. Heretofore it has been the practice of manually wrapping a tie wire around the intersecting steel reinforcing members (for example, rebar) in walls, mats, piers, tie beams, slabs, etc.

### SUMMARY

In accordance with an exemplary embodiment, a plurality of clips for joining reinforcing members comprises: at least two clips, each of the at least two clips comprising: a first pair of legs, each of the legs of the first pair of legs having a portion having a curvature thereto and adapted to wrap around a lower surface of a first reinforcing member; a second pair of legs, each of the legs of the second pair of legs having an inner surface adapted to exert a force against at least a portion of a side surface of a second reinforcing member, the second reinforcing member residing perpendicular to the first reinforcing member; and a mid-portion, which connects the first pair of legs to the second pair of legs; and a breakable connector positioned between the at least two clips, wherein the breakable connector attaches a pair of clips to one another, and upon a force thereto, the breakable connector separates the at least two clips from one another.

In accordance with another exemplary embodiment, a clip for joining reinforcing members, comprises: a first portion having a curvature thereto and adapted to wrap around a lower surface of a first reinforcing member; a second portion having a curvature thereto and adapted to exert a force against a side surface of a second reinforcing member, the second reinforcing member residing perpendicular to the first reinforcing member; and a mid-portion, which connects the first portion pair of legs to the second pair of legs.

In accordance with a further exemplary embodiment, a method of forming a plurality of clips for joining reinforcing members comprising: cutting one or more clips from a sheet of material, forming each of the one or more clips to have a first portion having a curvature thereto and adapted to wrap around a lower surface of a first reinforcing member, a second portion having a curvature thereto and adapted to exert a force against a side surface of a second reinforcing member, the second reinforcing member residing perpendicular to the first reinforcing member, and a mid-portion, which connects the first portion pair of legs to the second pair of legs.

In accordance with another exemplary embodiment, a clip for joining reinforcing members comprises: a first member having a cavity therein with an open end; a second member having a cavity therein with an open end; a handle, which extends outward from the first and/or second member; and wherein the first and second members are fixed to one another so that each of the open ends face in opposite directions, and the first and second members are perpendicular to one another.

In accordance with a further exemplary embodiment, a block for reinforcing members, comprises: a generally rectangular block having one or more openings therein, which extend from one end of the block to an opposite end thereof, and wherein each of the one or more openings is configured to receive at least one reinforcing member.

### BRIEF DESCRIPTION OF THE DRAWINGS

In the following, exemplary embodiments will be explained in greater detail in reference to drawings, wherein:

FIG. 1 is a top view of a pair of clips for joining reinforcing members for use in reinforced concrete slabs and/or columns in accordance with an exemplary embodiment.

FIG. 2 is a perspective view of the pair of clips for joining reinforcing members for use in reinforced concrete slabs and/or columns as shown in FIG. 19 in accordance with an exemplary embodiment.

FIGS. 3-5 is a series of views showing a clip for joining reinforcing members for use in reinforced concrete slabs and/or columns in use in accordance with an exemplary embodiment.

FIG. 6 is a perspective view of a plurality of clips on a rod for joining reinforcing members for use in reinforced concrete slabs and/or columns in accordance with an exemplary embodiment.

FIG. 7 is a perspective view of a plurality of clips on a rod for joining reinforcing members for use in reinforced concrete slabs and/or columns in accordance with another exemplary embodiment.

FIG. 8 are side views of clips for joining reinforcing members for use in reinforced concrete slabs and/or columns in accordance with one embodiment.

FIG. 9 are side views of clips for joining reinforcing members for use in reinforced concrete slabs and/or columns in accordance with the embodiment as shown in FIG. 8.

FIG. 10 are two side views and a top view of a clip for joining reinforcing members for use in reinforced concrete slabs and/or columns in accordance with another embodiment, which includes a plate or plate-like member.

FIG. 11 is top view of a clip for joining reinforcing members for use in reinforced concrete slabs and/or columns in accordance with another embodiment.

FIG. 12 is a perspective view of the clip for joining reinforcing members as shown in FIG. 11 in use with reinforcing members used in reinforced concrete slabs and/or columns.

FIG. 13 is perspective view of a clip for joining reinforcing members for use in reinforced concrete slabs and/or columns in accordance with another embodiment.

FIG. 14 is a perspective view of the clip for joining reinforcing members as shown in FIG. 13 in use with reinforcing members used in reinforced concrete slabs and/or columns in accordance with a further embodiment.

FIG. 15 is a perspective view of a clip for joining reinforcing members in use with reinforcing members used in reinforced concrete slabs and/or columns in accordance with another embodiment.

FIG. 16 is a top view of a strip of clips for joining reinforcing members for use in reinforced concrete slabs and/or columns in accordance with an embodiment.

FIG. 17 is a top view of a clip from a strip of clips for joining reinforcing members for use in reinforced concrete slabs and/or columns as shown in FIG. 16.

FIG. 18 is a perspective view of the clip from a strip of clips for joining reinforcing members for use in reinforced concrete slabs and/or columns as shown in FIG. 16.

FIG. 19 is top view of a clip from a strip of clips for joining reinforcing members for use in reinforced concrete slabs and/or columns as shown in FIG. 16 in accordance with another embodiment.

FIG. 20 is a perspective view of a clip for joining reinforcing members for use in concrete slabs and/or columns as shown in FIG. 18 in accordance with another embodiment wherein the clip is shown joining a pair of reinforcing members.

FIG. 21 is another perspective view of a clip for joining reinforcing members for use in concrete slabs and/or columns as shown in FIG. 18 and a hammer in accordance with another embodiment wherein the clip is shown joining a pair of reinforcing members.

FIG. 22 is a perspective view of a block or Dobie for joining reinforcing members in accordance with an exemplary embodiment.

FIG. 23 is another perspective view of a block or dobie for joining reinforcing members in accordance with another exemplary embodiment.

FIG. 24 is a top view of a plurality of reinforcing members with a plurality of blocks or dobies, which form a grid in accordance with an exemplary embodiment.

FIG. 25 is a top view of a clip for joining reinforcing members for use in concrete slabs and/or column having a pair of stiffening ribs in accordance with an exemplary embodiment.

FIG. 26 is a side view of a clip for joining reinforcing members for use in concrete slabs and/or column having a pair of stiffening ribs in accordance with an exemplary embodiment.

FIG. 27 is a side view of a stamping die for stamping the pair of stiffening ribs as shown in FIGS. 25 and 26 in one or more clips.

FIG. 28 is a side view of a die for stamping clips from a strip.

FIG. 29 is strip of clips before stamping by the die as shown in FIG. 28.

FIG. 30 is a perspective view of a block or Dobie for joining reinforcing members in accordance with an exemplary embodiment.

### DETAILED DESCRIPTION

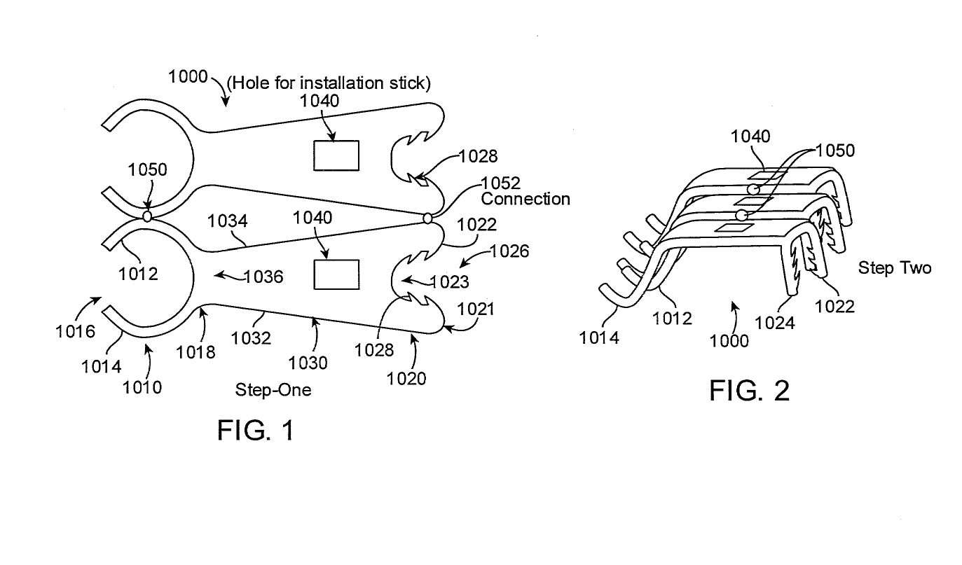

In accordance with an embodiment, a clip 1000 for joining reinforcing members 400, 500 for use in reinforced concrete slabs and/or columns is shown in FIG. 1. FIG. 1 is a top view of a pair of clips 1000 for joining reinforcing members for use in reinforced concrete slabs and/or columns in accordance with another exemplary embodiment, which are stamped from a sheet of metal and/or metal-like material. As shown in FIG. 1, each clip 1000 includes a first pair of legs 1010, which includes a first and a second legs 1012, 1014 having a curvature thereto and adapted to wrap around a lower surface 402 of a first reinforcing member 400. The first and second legs 1012, 1014 of the first pair of legs 1110 includes a distal end 1016 and a proximal end 1018. The distal end 1016 of the first pair of legs 1110 is a free end and the proximal end 1018 of the first pair of legs 1110 forms part of the transition from the first pair of legs 1110 to a mid-portion 1030 of the clip 1000.

As shown in FIG. 2, the first and second legs 1012, 1014 of the first pair of legs 1010 form an open distal end 1016, which includes a free end, which extends upward from the mid-portion 1013 of each of the first pair of legs 1010 of the clip 1000. As shown in FIG. 2, the distal ends 1016 have a length thereto and upward extension of only a portion of the proximal end 1018. For example, as shown in FIG. 2, the distal end portion or free end 1016 of each of the legs 1012, 1014 extends upward from the mid-portion 1013 approximately 10 to 90 percent of the relative distance to the mid-portion 1020 of the clip 1000, and more preferably approximately 25 to 75 percent of the distance of the mid-portion 1020. In accordance with an exemplary embodiment, by extending upward only a portion of the length as shown in FIG. 2, the distal end 1016 or free end portion of the clip 1000 wraps around a lower surface 402 of a first reinforcing member 400 with ease as compared to a fully curved distal end 1016.

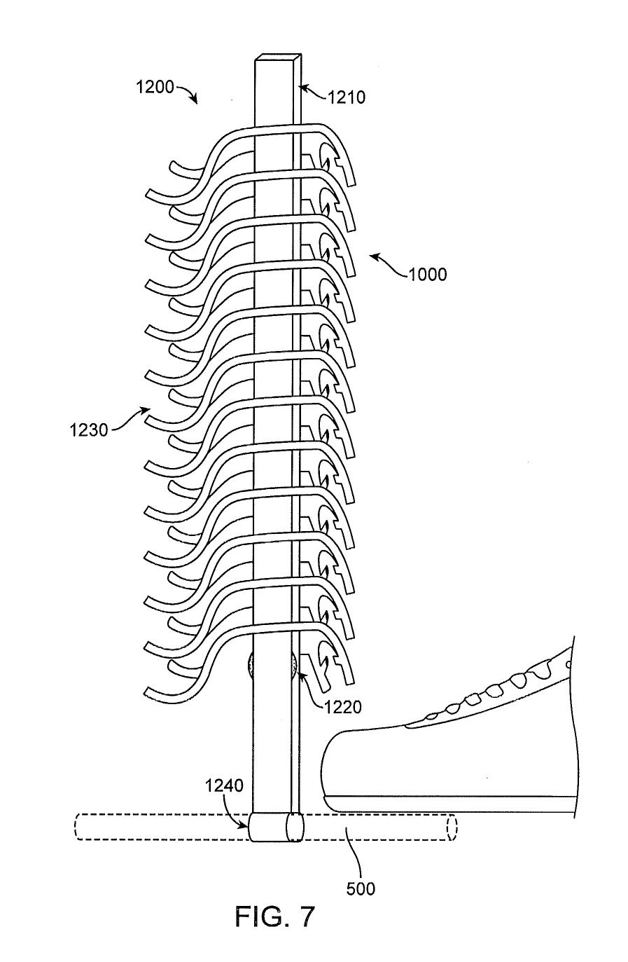

In accordance with an exemplary embodiment, the mid-portion 1030 is a solid plate, which extends from a proximal end 1018 of the pair of legs 1010, which coincides with the distal portion 1036 of the mid-portion 1030 of the clip. In accordance with an exemplary embodiment, the mid-portion 1030 includes an opening 1040, which is preferably rectangular or circular in shape, which receives a rod or other suitable device, which stacks a plurality of clips as shown in FIG. 7. In accordance with an exemplary embodiment, the mid-portion 1030 has a relatively flat distal portion 1036, which flares outward in a triangular shape to a proximal portion 1020.

The clip 1000 includes a proximal end 1020, which extends from the mid-portion 1030 and includes an open end 1026, which is formed from a pair of proximal legs or protrusions 1021, 1022. Each of the proximal legs or protrusions 1022, 1024, includes one or more teeth 1028 having a sharp edge thereto, which fits around a side surface 502 of a second reinforcing member 500 as the clip 1000 is lowered onto the an upper surface of the second reinforcing member 500. As shown in FIG. 1, each of the legs 1022, 1024 preferably has a rounded edge 1021 to assist with the installation of the clip around the side surfaces of the second reinforcing member 500.

In accordance with an exemplary embodiment, the pair of clips 1000 are connected to one another with one or more connections 1050, which are preferably positioned along a side portion of the one or more clips 1000 along the pair of legs 1010 and the proximal portion 1050. In accordance with an exemplary embodiment, rather than a pair of clips 1000 as shown in FIG. 2, a plurality of clips 1000 can be connected to one another in a side-by-side format. For example, two or more clips 1000 can be attached to one another in a strip of clips 1000, and wherein each clip 1000 from the strip of clips 1000 can be separated from the strip of clips 1000 as needed.

Alternatively, the one or more clips 1000 can be stacked on top of one another and an adhesive can be used to secure or adhere the one or more clips 1000 to one another. For example, a drop of an adhesive can be placed on an upper portion of the mid-portion 1030 of the clip 1000 and a lower portion of a second clip 1000 can be placed on top thereof.

FIG. 2 is a perspective view of the pair of clips 1000 for joining reinforcing members for use in reinforced concrete slabs and/or columns as shown in FIG. 1 in accordance with an exemplary embodiment. As shown in FIG. 2, the pair of clips 1000 can be connected to one another via one or more connections 1050. The one or more connections 1050 are preferably an adhesive or like material, which connects or adheres one or more clips 1000 to one another in a side-by-side manner. The one or more connections 1050 can be an adhesive or substance having a sticky or tacky feeling, which is usually in a liquid or semi-liquid state, and which adheres or bonds items together. Alternatively, the one or more connections 1050 can be an extension of the one or more clips 1000, which is formed during the molding and/or manufacturing process. For example, the one or more connections 1050 can be made of the same material as the one or more clips 1000, and upon application of a force thereto separates the one or more clips 1000 into individual clips 1000.

As shown in FIG. 2, the one or more connections 1050 are preferably positioned along a side portion of the one or more clips 1000 along the pair of legs 1010 and the proximal end 1020. Alternatively, the one or more clips 1000 can be stacked on top of one another and an adhesive can be used to secure or adhere the one or more clips 1000 to one another. For example, a drop of an adhesive can be placed on an upper portion of the mid-portion 1020 of the clip 1000 and a lower portion of a second clip 1000 can be placed on top thereof.

The clip 1000 is preferably manufactured from a stamped piece of metal. In accordance with an exemplary embodiment, a plurality of clips 1000 as shown in FIG. 1, are preferably cut from a sheet of metal into the desired shape as shown. In accordance with an exemplary embodiment, a die is pressed into a sheet of metal or metal-like material, which stamps out one or more clips 1000 having a two-dimensional shape thereto. The two-dimensional clip 1000 includes the first pair of legs 1010, which forms the open end 1016 of the clip 1000. The distal end 1016 of the first pair of legs 1010 is a free end and the proximal end 1018 of the first pair of legs 1010 forms a part of the transition from the first pair of legs 1010 to the mid-portion 1030. Once the clip has been laid out, the final shape of the clip 100 as shown in FIG. 1 is stamped into its final shape using a suitable metal forming machine and/or mandrel.

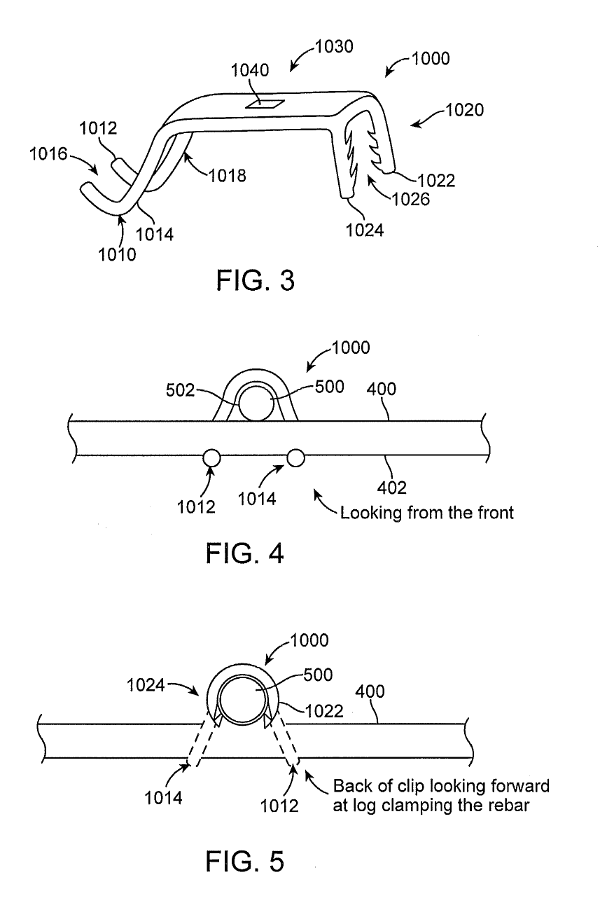

As shown in FIG. 3, the clip 1000 includes a first pair of legs 1010, a mid-portion 1030, and a proximal portion or second pair of legs 1020. Each of the legs of the first pair of legs 1010 has a portion having a curvature thereto and adapted to wrap around a lower surface 402 of a first reinforcing member 400 (FIG. 4). Each of the second pair of legs 1020 has an inner surface adapted to exert a force against at least a portion of a side surface 502 of a second reinforcing member 500, the second reinforcing member 500 residing perpendicular to the first reinforcing member 400.

FIG. 4 is an end view of the clip 1000, and a first reinforcing member 400, and a second reinforcing member 500. As shown in FIG. 4, the first pair of legs 1010, which includes a first leg 1012 and a second leg 1014 have a curvature thereto, which is configured to wrap around the lower surface of the first reinforcing member 400. Each of the second pair of legs 1020 has an inner surface adapted to exert a force against at least a portion of a side surface of the second reinforcing member 500.

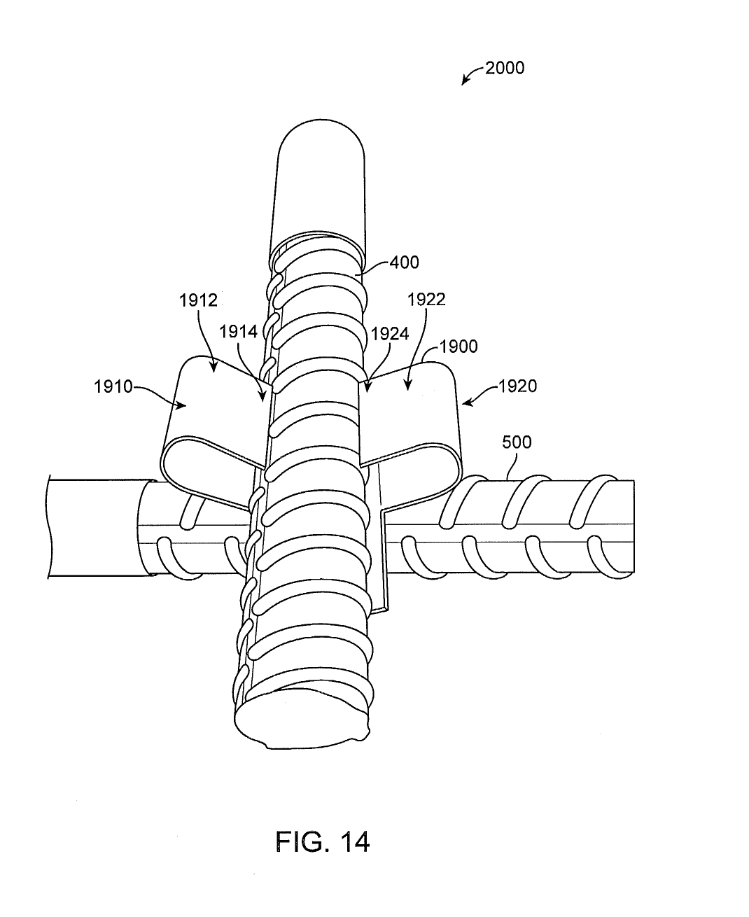

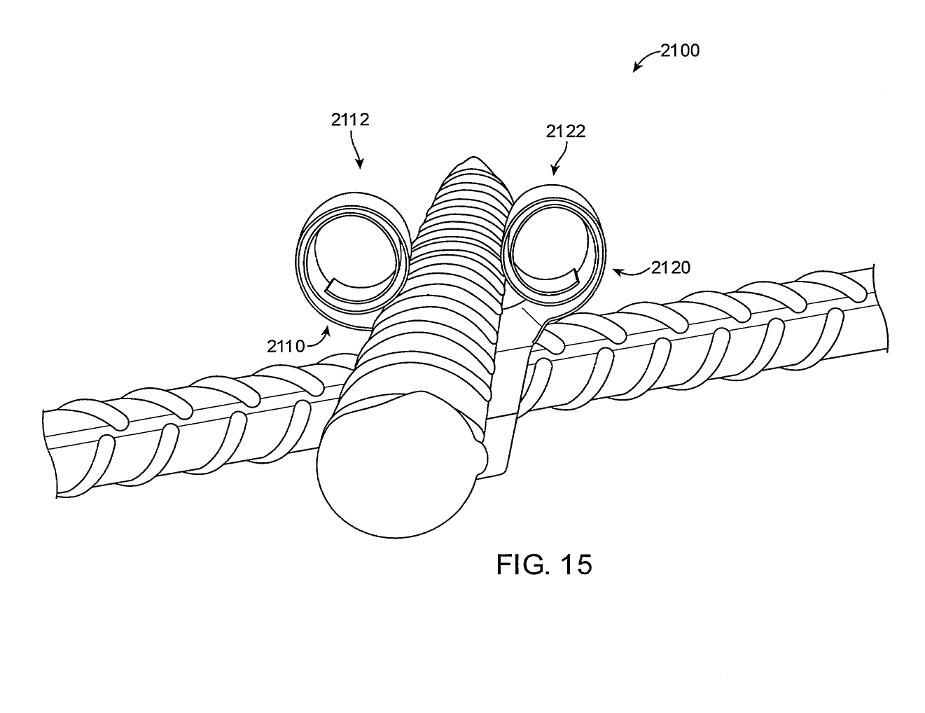

The first and second reinforcing members 400, 500, for example, can be a wire mesh, steel reinforcing rods or members (for example, steel rebar) or any other suitable material, which is used for reinforced concrete and reinforced masonry structures, including concrete slabs and/or columns. In accordance with an embodiment, the first and second reinforcing members 400, 500 are steel reinforcing members (e.g., rebar) formed from carbon steel with a plurality ridges or grooves (FIGS. 14 and 15), which extend around the outer circumference of the reinforcing members 400, 500, and also extending longitudinally or lengthwise. In accordance with an embodiment, the ridges or grooves can be a plurality of circular rings or other suitable circular pattern or shape. Alternatively, it can be appreciated that other non-circular patterns can be used. It can be appreciated that in reinforced concrete slabs and/or columns, the ridges or grooves provide frictional adhesion for the concrete. In addition, the first and second reinforcing members 400, 500 preferably have a coefficient of expansion, which is approximately equal to that of the concrete to provide for a stable slab and/or column.

FIG. 5 is another end view from the proximal end 1020 of the clip 1000 wrapped around a lower surface 402 of a first reinforcing member 400. Each of the second pair of legs 1020 has an inner surface adapted to exert a force against at least a portion of a side surface 502 of a second reinforcing member 500, the second reinforcing member 500 residing perpendicular to the first reinforcing member 400.

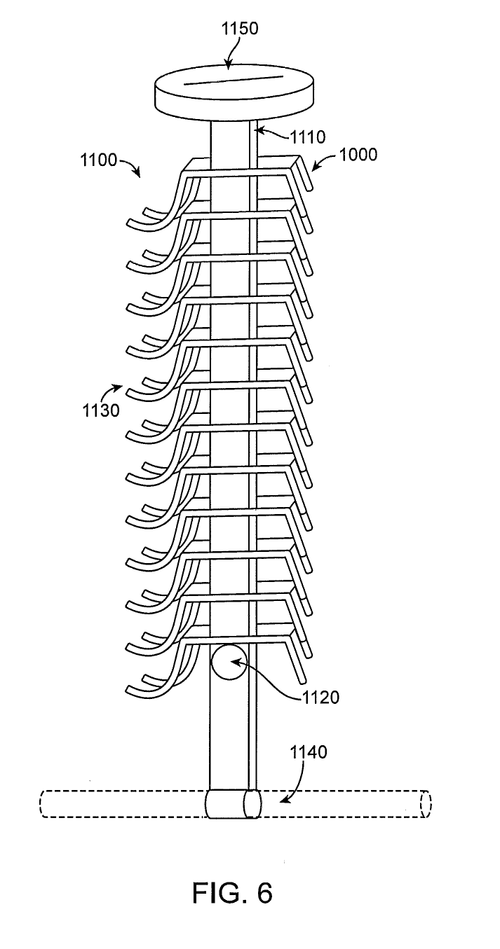

FIG. 6 is a perspective view of a plurality of clips 1000 on a rod 1100 for joining reinforcing members for use in reinforced concrete slabs and/or columns in accordance with an exemplary embodiment. The mid-portion 1040 has an opening therein, which is sized to fit around a rod or rod-like member 1110. The rod or rod-like member 1110 preferably has a rectangular cross-section thereto, which is sized to receive a plurality of clips 1000, which are stacked on top of one another. The rod or rod-like member 1110 has one or more stops or stop-like protrusions 1120 located on a lower surface thereof and which are configured to prevent the clips 1000 from sliding to a distal end of the rod. The one or more stops 1120 preferably extend outward from the rod and upon a lower edge of one of the stack of clips 10010000 positioned on the rod 1110. The one or more stops 1120 can be located on one or more of the four edges of a rectangular rod 1110. In accordance with an exemplary embodiment, the rod 1110 is preferably made of wood, plastic, and/or other suitable material, which provides enough strength to hold a plurality of clips 1000 as shown in FIGS. 1 and 2. The one or more stops 1120 are preferably rubber, metal or wood and extend outward from the rod or rod-like member 1110 as described above.

In accordance with an exemplary embodiment, the rod 1110 can be between 3 to 6 feet in length, for example, 4 to 5 feet in length and can be designed to hold upwards of 60 to 180 clips 1000. The clips 1000 are installed from the top of the rod 1110 and can be added at an initial loading, or alternatively, can be added as needed. Upon loading of the rod 1110 with the plurality of clips 1000, the clips 1000 stack on top of one another, with a distal portion of the first pair of legs 1010 resting on top and/or beneath a corresponding portion of an adjacent clip 1000, and the mid-portion 1030 of adjacent clips 1000 resting on top of one another to provide a spacing between clips of at least 0.25 inches (¼ inch) and more preferably at least 0.50 inches (½ inch) between adjacent clips. The rod 1110 also includes a pair of guide wires or plates 1150, which positions the rod on the first and/or second reinforcing member 400, 500. The guide wires or plates 1150 preferably straddles the first and/or second reinforcing member 500 to assist with holding the clip 1000 in a proper position for installation.

In accordance with an exemplary embodiment, the lower-most (or bottom) clip 1000 in a stack of clips 1000 is held in place just above the stop or stop-like member 1120 until the user by hand and/or foot applies a downward force or pressure on an upper portion of the clip 1000, which causes the clip 1000 to move over and around the stop 1120 onto the first and/or second reinforcing member 400, 500. The adjacent clips 1000 each move downward such that the second most lower clip 1000 is resting on an upper surface of the stop 1120

In accordance with an exemplary embodiment, the clips 1000 can be attached to the rod 1110 at the factory using an adhesive, glue or other suitable material, which causes the clips 1000 to be fixed and/or attached to rod 1110 for delivery to the user.

FIG. 7 is a perspective view of a plurality of clips 1000 on a rod 1200 for joining reinforcing members for use in reinforced concrete slabs and/or columns in accordance with another exemplary embodiment. As shown in FIG. 7, the rod 1200 is designed to receive a plurality of clips 1000 as shown in FIGS. 1 and 2. As shown in FIG. 7, each clip 1000 includes a first pair of legs 1010, which includes a pair of legs 1012, 1014 having a curvature thereto and adapted to wrap around a lower surface of a first reinforcing member 400, and a mid-portion 1030, which includes a solid plate, which extends from a proximal end 1018 of the pair of legs 1010, which coincides with the distal portion 1036 of the mid-portion 1030 of the clip. In accordance with an exemplary embodiment, the mid-portion 1030 includes an opening 1040, which is preferably rectangular or circular in shape, which receives the rod 1210 as shown in FIG. 7. In accordance with an exemplary embodiment, the mid-portion 1030 has a relatively flat distal portion 1036, which flares outward in a triangular shape to a proximal portion 1020.

The clip 1000 includes a proximal end 1020, which extends from the mid-portion 1030 and includes an open end 1026, which is formed from a pair of proximal legs or protrusions 1021, 1022. Each of the proximal legs or protrusions 1022, 1024, includes one or more teeth 1028 having a sharp edge thereto, which fits around a side surface 502 of a second reinforcing member 500 as the clip 1000 is lowered onto the an upper surface of the second reinforcing member 500. As shown in FIG. 19, each of the legs 1022, 1024 preferably has a rounded edge 1021 to assist with the installation of the clip around the side surfaces of the second reinforcing member 500.

The rod or rod-like member 1210 preferably has a rectangular cross-section thereto, which is sized to receive a plurality of clips 1000, which are stacked on top of one another. The rod or rod-like member 1210 has one or more stops or stop-like protrusions 1220 located on a lower surface thereof and which are configured to prevent the clips 1000 from sliding to a distal end of the rod. The one or more stops 1220 preferably extend outward from the rod and upon a lower edge of one of the stack of clips 1000 positioned on the rod 1210. The one or more stops 1220 can be located on one or more of the four edges of a rectangular rod 1210. In accordance with an exemplary embodiment, the rod 1210 is preferably made of wood, plastic, and/or other suitable material, which provides enough strength to hold a plurality of clips 1000 as shown in FIGS. 1 and 2. The one or more stops 1220 are preferably rubber, metal or wood and extend outward from the rod or rod-like member 1210 as described above.

In accordance with an exemplary embodiment, the clips 1000 can be attached to the rod 1210 at the factory using an adhesive, glue or other suitable material, which causes the clips 1000 to be fixed and/or attached to rod 1210 for delivery to the user.

The rod 1210 can be between 3 to 6 feet in length, for example, 4 to 5 feet in length and can be designed to hold upwards of 60 to 180 clips 1000. The clips 1000 are installed from the top of the rod 1210 and can be added at an initial loading, or alternatively, can be added as needed. Upon loading of the rod 1210 with the plurality of clips 1000, the clips 1000 stack on top of one another, with a distal portion of the first pair of legs 1010 resting on top and/or beneath a corresponding portion of an adjacent clip 1000, and the second pair of legs 1020 of adjacent clips 1000 resting on top of one another to provide a spacing between clips of at least 0.25 inches (¼ inch) and more preferably at least 0.50 inches (½ inch) between adjacent clips. The rod 1210 also includes a pair of guide wires or plates 1250, which positions the rod on the first and/or second reinforcing member 400, 500. The guide wires or plates 1250 preferably straddles the first and/or second reinforcing member 500 to assist with holding the clip 1000 in a proper position for installation.

In accordance with an exemplary embodiment, the lower-most (or bottom) clip 1000 in a stack of clips 1000 is held in place just above the stop or stop-like member 1220 until the user by hand and/or foot applies a downward force or pressure on an upper portion of the clip 1000, which causes the clip 1000 to move over and around the stop 1220 onto the first and/or second reinforcing member 400, 500. The adjacent clips 1000 each move downward such that the second most lower clip 1000 is resting on an upper surface of the stop 1220.

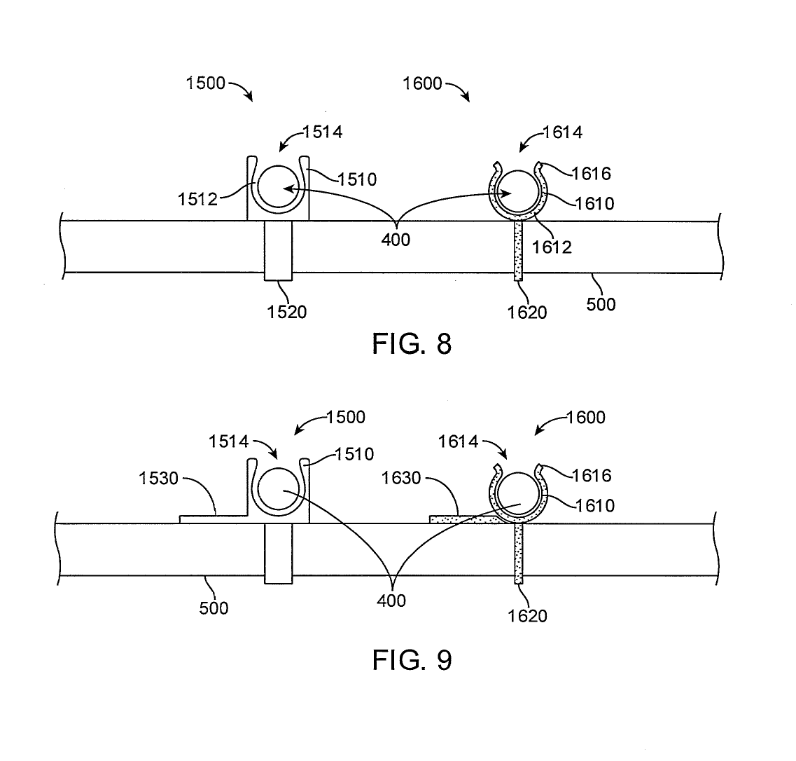

FIGS. 8 and 9 show another exemplary embodiment of a clip 1500, 1600 for joining reinforcing members 400, 500 for use in reinforced concrete slabs and/or columns. The clip 1500, 1600 is configured to join or attach a pair of structural members 400, 500 together. As shown in FIGS. 8 and 9, the clip 1500, 1600 is comprised of a first member 1510, 1610 and a second member 1520, 1620, which are attached or fixed to one another. In accordance with an exemplary embodiment, each of the first and second members 1510, 1520, 1610, 1620 have a groove or cavity 1512, 1612, with an open end 1514, 1614, which is configured to receive one of the pair of structural members 400, 500.

As shown in FIGS. 8 and 9, the groove or cavity 1512, 1612 is preferably semi-circular in shape with an open end 1514, 1614, which allows the clip 1500, 1600 to snap into place and around the reinforcing members 400, 500. The first and second members 1510, 1520, 1610, 1620 are fixed to one another so that each of the open ends 1514, 1614 face in opposite directions, and the first and second members 1510, 1520, 1610, 1620 are perpendicular to one another (for example, 90 degrees to one another).

In accordance with an exemplary embodiment, the clip 1500 can be manufactured from a plastic or plastic-like material. The clip 1500 includes a first member 1510 having a groove or cavity therein 1512 with an open end 1514, which is configured to receive one of the pair of structural members 400, 500. The second member 1520 has a groove or cavity 1522 with an open end 1524, which is configured to receive the other of the pair of structural members 400, 500. The clip 1500 can also include an optional handle 1530, which attaches or extends outward from a lower portion of the first or second member 1510, 1520. The clip 1500 is preferably injected molded using plastic material, which can be any of a wide range of synthetic or semi-synthetic organic solids used in the manufacture of industrial products. For example, the plastic or plastic-like material can be any suitable polymers of high molecular mass, and which contain other substances to improve performance and/or reduce production costs.

In accordance with another exemplary embodiment as shown in FIGS. 8 and 9, the clip 1600 can also be manufactured from a wire or wire-like material, such a steel or spring steel, which includes a first member 1610 and a second member 1620, which are attached or fixed to one another. The first member 1610 is preferably a circular clip or fastener consisting of a first semi-flexible metal ring 1616 with an open end 1614, which can be snapped into place and around the first reinforcing member 400. As shown in FIGS. 8 and 9, the first member 1610 fits around one or the pair of structural members 400, 500. A second member 1620 is attached or fixed to the first member 1610. The second member 1620 also preferably consists of a second semi-flexible metal ring 1616 with an open end 1614, which can be snapped into place and around the second reinforcing member 500. Each of the first and second members 1610, 1620 can also include a slightly curved distal ends 1626, 1628, which assists with the ease of inserting the first and second reinforcing members 400, 500 into the groove or cavity 1612, which is located within the inner portion of each of the semi-flexible rings 1616.

The clips 1000, 1500, 1600 can be made of a stiff resiliently yielding material, such as spring steel. For example, in accordance with an embodiment, the clips 1000, 1500, and 1600 can be made from a high-carbon spring steel, alloy spring steel, a stainless spring steel, a copper-base spring alloy, and/or a nickel-base spring alloy.

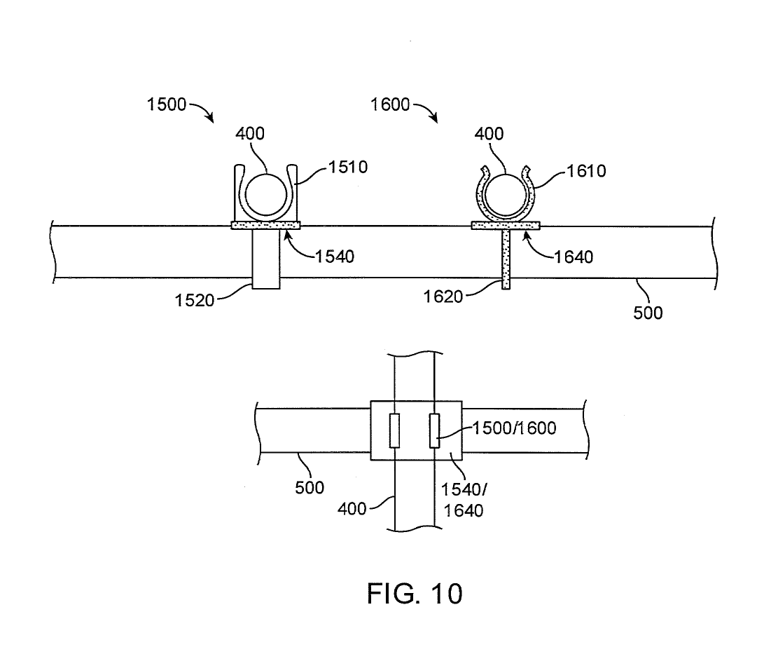

FIG. 10 are side views of clips 1500, 1600 and a top view of a clip for joining reinforcing members for use in reinforced concrete slabs and/or columns in accordance with another embodiment. As shown in FIG. 10, the clips 1500, 1600 include a plate or plate-like member 1540, 1640, which is attached or fixed between the first member 1510, 1610, and the second member 1520, 1620. The plate 1540, 1640 balances the clip and prevents the clip from moving from side to side during use. In accordance with an exemplary embodiment, the plate 1540, 1640, is made of the same or a similar material as the clip 1500, 1600. For example, the plate 1540, 1640 is preferably made of plastic or metal, respectively.

As shown in FIGS. 8-10, the clip 1500, 1600 prevents lateral movement of the pair of structural members 400, 500. Each of the grooves or cavities 1512, 1612 are configured to receive and wrap around a lower surface and edges (or side surfaces) of a first reinforcing member 400, and an upper surface and edges (or side surfaces) of the second reinforcing member 500.

As described herein, the first and second reinforcing members 400, 500 can be a wire mesh, steel reinforcing rods or members (for example, steel rebar) or any other suitable material, which is used for reinforced concrete and reinforced masonry structures, including concrete slabs and/or columns. In accordance with an embodiment, the first and second reinforcing members 400, 500 are steel reinforcing members (for example, rebar) formed from carbon steel with a plurality ridges or grooves (not shown), which extend around the outer circumference of the reinforcing members, and also extending longitudinally or lengthwise. In accordance with an embodiment, the ridges or grooves can be a plurality of circular rings or other suitable circular pattern or shape. Alternatively, it can be appreciated that other non-circular patterns can be used. It can be appreciated that in reinforced concrete slabs and/or columns, the ridges or grooves provide frictional adhesion for the concrete. In addition, the first and second reinforcing members 400, 500 preferably have a coefficient of expansion, which is approximately equal to that of the concrete to provide for a stable slab and/or column.

In accordance with an exemplary embodiment, the clips 1500, 1600 are preferably sized to accommodate a specific size of reinforcing members or rebar. For example, preferably the cavity or groove with each of the clips 1500, 1600 is approximately or slightly smaller than an outer diameter of the reinforcing members 400, 500 so as to provide a tight fit around the reinforcing members during use. In addition, as shown in FIGS. 8 and 9, each of the first and second members 1510, 1520, 1610, 1620 has a thickness (or width), which is approximately 0.01 to 0.5 of the diameter of the reinforcing members 400, 500, and more preferably approximately 0.1 to 0.3 of the diameter of the reinforcing members 400, 500.

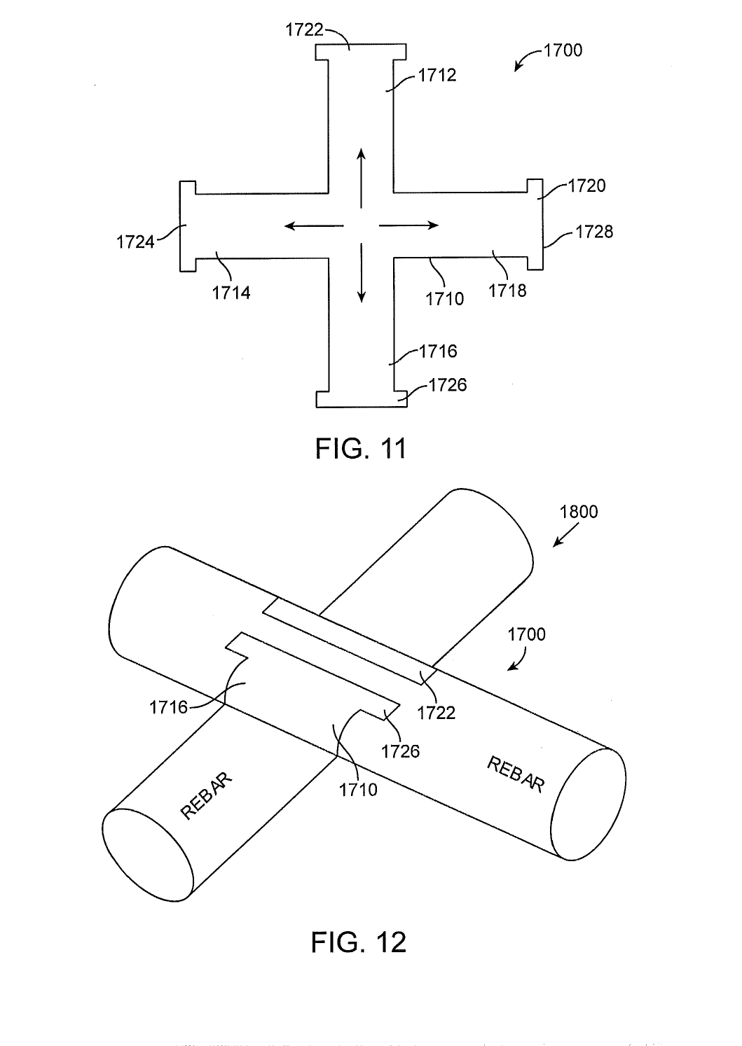

FIG. 11 is top view of a clip 1700 for joining reinforcing members for use in reinforced concrete slabs and/or columns in accordance with another embodiment. In accordance with an exemplary embodiment, the clip 1700 is preferably formed from a stamped piece of metal or metal-like material, such as spring steel in a shape of a cross. As shown in FIG. 11, the clip 1700 has four (4) sections thereto, which include a first section 1712, a second section 1714, a third section 1716, and a fourth section 1718, which are each essentially rectangular in shape and having a common middle portion, which they extend therefrom.

In accordance with another exemplary embodiment, each of the four sections, 1712, 1714, 1716, 1718, optionally includes a rectangular extension 1722, 1724, 1726, 1728, attached to a distal end of each of the four rectangular sections 1712, 1714, 1716, 1718. The rectangular extension 1722, 1724, 1726, 1728 is configured to extend perpendicular to each of the four sections 1712, 1714, 1716, 1718. In accordance with an exemplary embodiment, the rectangular extensions 1722, 1724, 1726, 1728 provide an added extension or lip, which extends around one of the first or second reinforcing members 400, 500, and secures the clip 1700 to one of the first and second reinforcing members 400, 500.

FIG. 12 is a perspective view of the clip 1700 for joining reinforcing members as shown in FIG. 11 in use with reinforcing members used in reinforced concrete slabs and/or columns. As shown in FIG. 12, the clip 1700 is designed such that two of the four sections, for example, sections 1714, 1718, are designed to wrap around one of the first or second reinforcing members 400, 500, and the other two sections 1712, 1716 wrap around the other of the first and second reinforcing members 400, 500. In accordance with an exemplary embodiment, the rectangular extensions 1712, 1714, 1716, 1718 provide added resistance and/or pressure to an upper and a lower surface of the corresponding reinforcing member 400, 500.

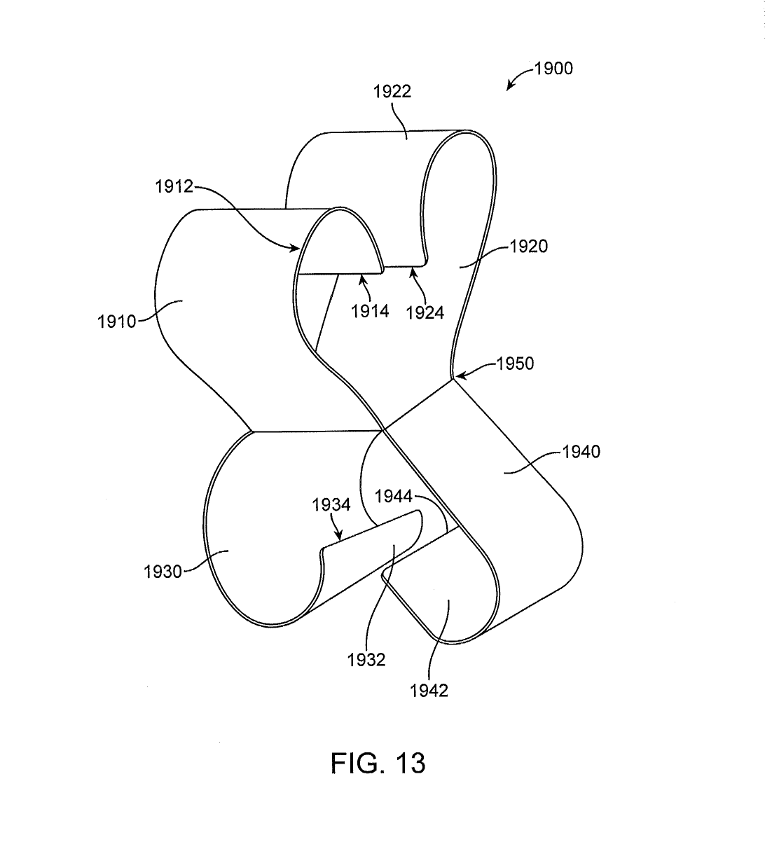

FIG. 13 is perspective view of a clip 1900 for joining reinforcing members 400, 500 (not shown) for use in reinforced concrete slabs and/or columns in accordance with another embodiment. As shown in FIG. 13, the clip 1900 includes four spring-like sections 1910, 1920, 1930, 1940, each of the spring-like sections 1910, 1920, 1930, 1940 having a curved portion thereto 1912, 1922, 1932, 1942, which is configured to receive a reinforcing member 400, 500 on a distal end 1914, 1924, 1934, 1944 of the curved portion 1912, 1922, 1932, 1942. Each of the pairs 1910, 1920, or 1930, 1940 received the reinforcing member 400, 500 by expanding outward and allowing the distal end 1914, 1924, 1934, 1944 of each of the four sections 1910, 1920, 1930, 1940 to be pressed against an outer surface of the reinforcing member 400, 500. Each pair of curved portions 1912, 1922, 1932, 1942 acts as a spring like member, and expands outward to receive the reinforcing members 400, 500 and then contracts around the reinforcing members 400, 500, which holds or secures the reinforcing members 400, 500 within the clip 1900. The clip 1900 also includes a mid-portion or transition section 1950, which is a rectangular plate or similar shape, which acts a base member for each pair of sections 1910, 1920, 1930, 1940. In accordance with an exemplary embodiment, the distal ends 1914, 1924, 1934, 1944 provide added resistance and/or pressure to an upper and a lower surface of the corresponding reinforcing member 400, 500.

For example, the clip 1900 as shown in FIG. 13 can be made from a stiff resiliently yielding material, such as spring steel. In accordance with an embodiment, the clip 1900 can be made from a high-carbon spring steel, alloy spring steel, a stainless spring steel, a copper-base spring alloy, and/or a nickel-base spring alloy.

FIG. 14 is a perspective view of a system 2000, which includes the clip 1900 for joining reinforcing members as shown in FIG. 13 in use with reinforcing members used 400, 500 in reinforced concrete slabs and/or columns. As shown in FIG. 14, each pair of spring-like sections 1910, 1920, and 1930, 1940 are configured to receive the reinforcing member 400, 500 by expanding outward and allowing the distal end 1914, 1924, 1934, 1944 of each of the four sections 1910, 1920, 1930, 1940 to be pressed against an outer surface of the reinforcing member 400, 500. Each pair of curved portions 1912, 1922, 1932, 1942 acts as a spring like member, and expands outward to receive the reinforcing members 400, 500 and then contracts around the reinforcing members 400, 500, which holds or secures the reinforcing members 400, 500 within the clip 1900.

FIG. 15 is a perspective view of a clip 2100 for joining reinforcing members in use with reinforcing members 400, 500 used in reinforced concrete slabs and/or columns in accordance with another embodiment. As shown in FIG. 15, the clip 2100 includes two pairs of coil section 2110, 2120, 2130, 2140, which each comprised of a coiled member 2112, 2122, 2132, 2142. The coiled members 2112, 2122, 2132, 2142 act like a spring, which receives the reinforcing members 400, 500. The coiled members 2112, 2122, 2132, 2142, expand outward to receive the reinforcing members 400, 500 and exert a pressure or force against an outer surface of the reinforcing members 400, 500 to hold or secure the reinforcing member 400, 500 between each pair of coiled members 2112, 2122, 2132, 2142.

In accordance with an exemplary embodiment, the clips 1900, 2000, 2100 can be formed from two separate relatively straight sections, which are bent as disclosed above and spot welded or clinched to one another as shown in FIGS. 13-15.

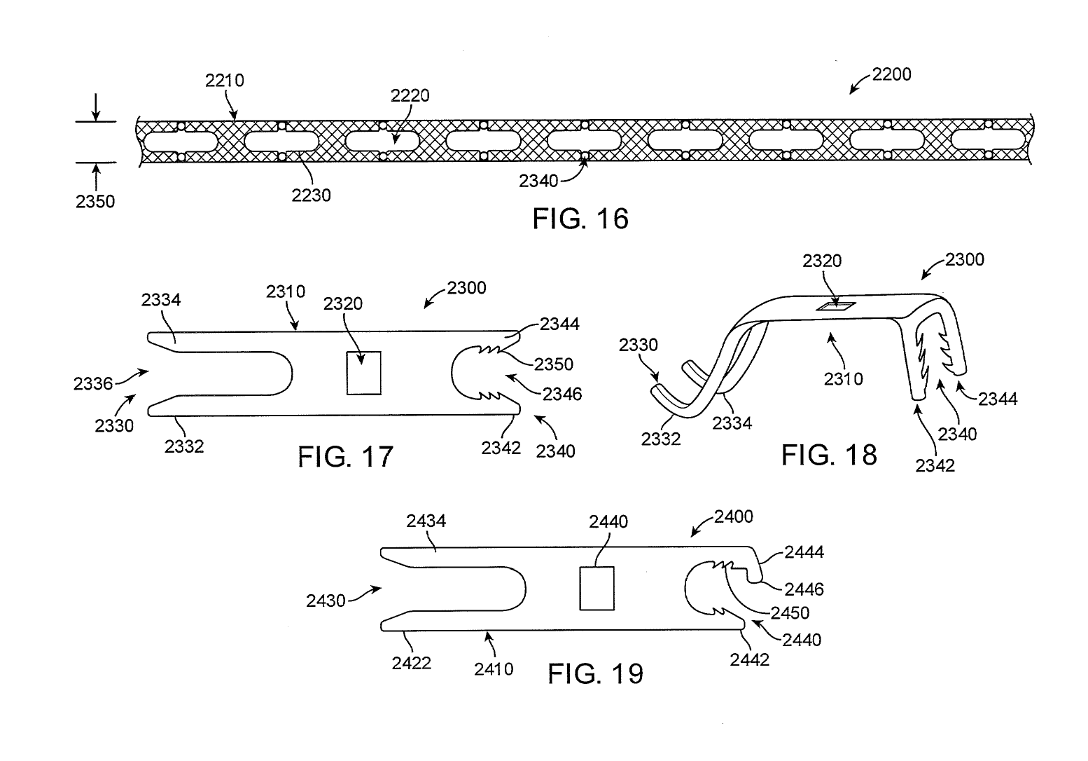

FIG. 16 is a top view of a strip of clips 2200 for joining reinforcing members for use in reinforced concrete slabs and/or columns in accordance with an embodiment. As shown in FIG. 16, the strip of clips 2200 is a strip of a stiff resiliently yielding material, such as spring steel, a high-carbon spring steel, an alloy spring steel, a stainless spring steel, a copper-base spring alloy, a nickel-base spring alloy and/or an iron based metal. The strip of clips is a narrow or thin strip of metal, which is fed into a forming device or metal forming stamp. The strip 2200 is fed from a spool into a stamping device or metal forming device, which stamps out the respective portion of each of the individual clips 2200, 2400 by removing a portion of strip.

Each of the openings 2220 within the strip of clips 2220 can corresponding to one pair of legs 2330, 2430, 2340, 2440 for two adjacent clips wherein the opening forms two pairs of first pair of legs or two pairs of second legs, or alternatively, the openings 2230 can correspond to a first pair of legs 2330 and a second pair of legs 2340 for another clip 2300. The strip 2200 of clips preferably have an outer edge 2210 which defines a width of the clip and one or more pressed portions, which allows the clips 2300 to be pressed or rather easily separated from one another upon stamping and/or pressing of the strip of clips 2200 through the metal stamping device or press.

FIG. 17 is a top view of a clip 2300 from a strip of clips 2200 for joining reinforcing members for use in reinforced concrete slabs and/or columns as shown in FIG. 16. As shown in FIG. 17, the clip 2300 has not been shaped into a clip. Rather the clip 2300 is relatively flat, which can be stored and/or shipped in a strip and a plurality of clips, which have not placed into a die or pressed into a three-dimensional shape. The clip 2300 includes a first pair of legs 2330, a mid-portion 2310, and a proximal portion or second pair of legs 2320. Each of the legs 2312, 2314 of the first pair of legs 2330 has a portion having a curvature thereto and adapted to wrap around a lower surface 402 of a first reinforcing member 400. Each of the legs 2342, 2344 of the second pair of legs 2340 has an inner surface adapted to exert a force against at least a portion of a side surface 502 of a second reinforcing member 500, the second reinforcing member 500 residing perpendicular to the first reinforcing member 400.

As shown in FIG. 17, the first pair of legs 2330 includes a pair of legs 2332, 2334, which form an opening 2336, which is configured to wrap around a lower surface 402 of first reinforcing member 400. The opening 2336 extends towards the mid-portion 2310 of the clip 2300. In accordance with an embodiment, the proximal end 2338 of the opening 2336 has a curvature thereto or round edge, which sits on top of upper surface of the first reinforcing member 400. The mid-portion 2310 has a rectangular opening 2320, which assist with the stacking of a plurality of clips 2300 on a stick or guide member. The proximal portion or second pair of legs 2340 include a second pair of legs 2342, 2344, which form a second opening 2346 on the proximal end of the clip 2340. On the inner portion of the second opening 2346 a series of teeth or protrusions assist with securing the proximal portion on upper surface of the second reinforcing member 500. The second opening 2346 extends towards the mid-portion 2310 or distal end of the clip 2300. The distal end 2348 of the second opening 2346 has a curvature or round edge, which assists with the placement of the clip 2300 on the upper surface of the second reinforcement member 500.

FIG. 18 is a perspective view of the clip 2300 from a strip of clips for joining reinforcing members for use in reinforced concrete slabs and/or columns as shown in FIG. 16. Once the openings 2220 and 2230 have been stamped into the strip 2200 of clips, the clips 2300 are separated into individual clips 2300 and pressed into a three-dimensional shape as shown in FIG. 18. The clips 2300 are pressed into a three-dimensional shape with a press or die.

FIG. 19 is top view of a clip 2400 from a strip of clips for joining reinforcing members for use in reinforced concrete slabs and/or columns as shown in FIG. 16 in accordance with another embodiment. As shown in FIG. 19, the clip 2300 has not been shaped into a clip. Rather the clip 2400 is relatively flat, which can be stored and/or shipped in a strip and a plurality of clips, which have not been shaped. The clip 2400 includes a first pair of legs 2430, a mid-portion 2410, and a proximal portion or second pair of legs 2420. Each of the legs 2412, 2414 of the first pair of legs 2430 has a portion having a curvature thereto and adapted to wrap around a lower surface 402 of a first reinforcing member 400. Each of the legs 2442, 2444 of the second pair of legs 2440 has an inner surface adapted to exert a force against at least a portion of a side surface 502 of a second reinforcing member 500, the second reinforcing member 500 residing perpendicular to the first reinforcing member 400.

As shown in FIG. 19, the first pair of legs 2430 includes a pair of legs 2432, 2434, which form an opening 2436, which is configured to wrap around a lower surface 402 of first reinforcing member 400. The opening 2436 extends towards the mid-portion 2410 of the clip 2400. In accordance with an embodiment, the proximal end 2438 of the opening 2436 has a curvature thereto or round edge, which sits on top of upper surface of the first reinforcing member 400. The mid-portion 2410 has a rectangular opening 2420, which assist with the stacking of a plurality of clips 2400 on a stick or guide member. The proximal portion or second pair of legs 2440 include a second pair of legs 2442, 2444, which form a second opening 2446 on the proximal end of the clip 2440. On one leg of the second pair of legs 2444 includes a hooked portion 2452, which assists with wrapping around a lower surface of the second reinforcing member 500. In accordance with an exemplary embodiment, on the inner portion of the second opening 2446, a series of teeth or protrusions 2450 can assist with securing the proximal portion on upper surface of the second reinforcing member 500. The second opening 2446 extends towards the mid-portion 2410 or distal end of the clip 2400. The distal end 2448 of the second opening 2446 has a curvature or round edge, which assists with the placement of the clip 2400 on the upper surface of the second reinforcement member 500.

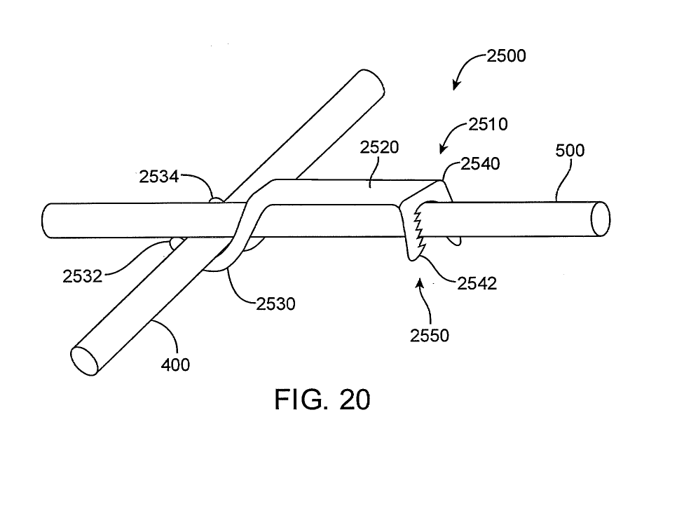

FIG. 20 is a perspective view of a clip 2500 for joining reinforcing members for used in concrete slabs and/or columns as shown in FIG. 18 in accordance with another embodiment wherein the clip is shown joining a pair of reinforcing members. As shown in FIG. 20, the clip 2500 includes body portion 2510 having a first pair of legs 2530, a mid-portion 2520, and a proximal portion or second pair of legs 2440. Each of the legs 2532, 2534 of the first pair of legs 2530 has a portion having a curvature thereto and adapted to wrap around a lower surface 402 of a first reinforcing member 400. Each of the legs 2542, 2544 of the second pair of legs 2540 has an inner surface adapted to exert a force against at least a portion of a side surface 502 of a second reinforcing member 500, the second reinforcing member 500 residing perpendicular to the first reinforcing member 400.

As shown in FIG. 20, the first pair of legs 2530 includes a pair of legs 2532, 2534, which form an opening, which is configured to wrap around a lower surface 402 of first reinforcing member 400. The opening extends towards the mid-portion 2520 of the clip 2500. In accordance with an embodiment, the proximal end of the opening has a curvature thereto or round edge, which sits on top of upper surface of the first reinforcing member 400. The proximal portion or second pair of legs 2540 includes a second pair of legs 2542, 2544, which form a second opening on the proximal end of the clip 2500. The distal end of the second opening 2446 has a curvature or round edge, which assists with the placement of the clip 2400 on the upper surface of the second reinforcement member 500.

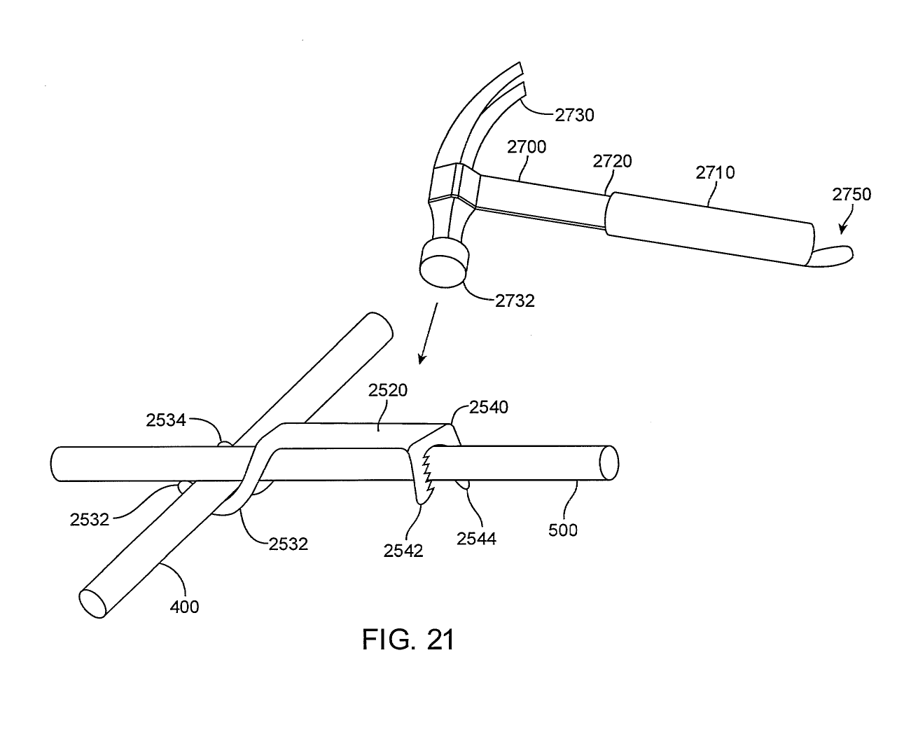

FIG. 21 is another perspective view of a clip 2500 for joining reinforcing member for used in concrete slabs and/or columns as shown in FIG. 18 and a hammer 2700 in accordance with another embodiment wherein the clip is shown joining a pair of reinforcing members. As shown in FIG. 21, the hammer 2700 includes a head 2740 having a claw like hook 2730 for removing nails and the like one end and a hammerhead 2732 for assisting with the fitting or placement of the clip 2500 on an upper surface of a reinforcing member 500. The hammer also includes a neck portion 2720, a handle 2710, and a clip or protrusion portion 2750 on the distal end, which helps with placement of the clip 2500 on the two reinforcing members 400, 500. In accordance with an exemplary embodiment, the clip 2500 can be pushed onto the reinforcing members 400, 500 and/or hammered onto the reinforcing members 400, 500 using the hammer 2700. For example, for larger or heavier clips 2500, the hammering of the clip 2500 can provide greater stability and strength, which can replace other methods requiring additional strength, e.g., welding.

The clip 2500 as shown in FIGS. 20 and 21 is preferably stamped from a sheet of metal or like materials as shown in FIG. 16 in a flat or relatively flat configuration. The clip 2500 can then be formed using metal forming equipment as known in the art.

The clips 1000, 1500, 1600, 1700, 1900, 2100, 2300, 2400, 2500 as shown in FIGS. 1-21, 25, and 26 can be sold in packages of 100 or more. In addition, each of the clips 1000, 1500, 1600, 1700, 1900, 2100, 2300, 2400, 2500 can be manufactured in different sizes to accommodate reinforcing members 400, 500 having diameters of 0.25 inches (¼ inch), 0.50 inches (½ inch), 0.75 inches (¾ inches), 1.00 inch (one inch) and any other suitable diameter of reinforcing members 400, 500.

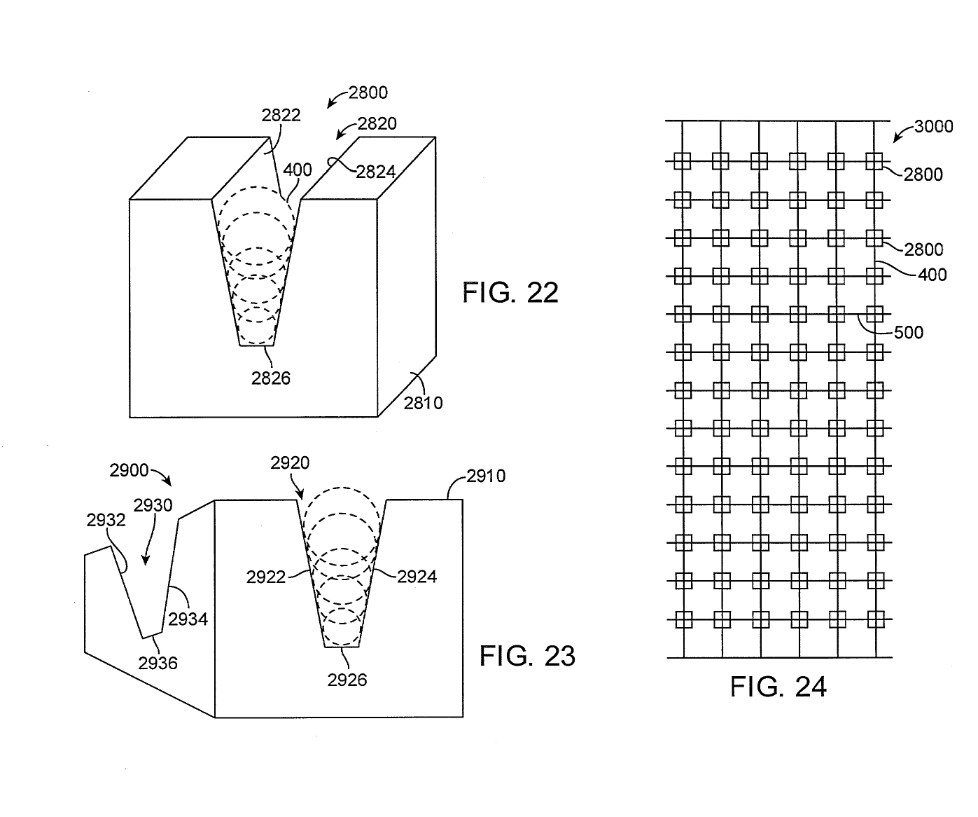

FIG. 22 is a perspective view of a block or Dobie 2800 for joining reinforcing members in accordance with an exemplary embodiment. As shown in FIG. 22, the block or Dobie 2800 includes a generally rectangular block 2810 having an opening 2820, which is configured to receive a reinforcing member 400. The opening 2820 includes a pair of angled walls 2822, 2824, and a base member 2826. The opening 2820 extends from a front portion to a back portion of the block 2810. In accordance with an alternative embodiment, the pair of angled walls 2822, 2824 can intersect one another such that the base member 2826 is not present within the block. In accordance with an exemplary embodiment, the pair of angled walls 2822, 2824 is configured to receive a plurality of different sizes of reinforcing members or rebar 400, 500. In addition, rather than a pair of angled walls 2822, 2824 in a V shape, the walls can be vertical or any other shape, which extend downward to the base member 2826, which is configured to support a lower portion of a reinforcing member 400, 500. For example, rather than a V shape, the angled walls 2822, 2824 can be vertical and/or rounded.

The block or Dobie 2800 is configured to lift or raise the connected reinforcing members off the surface or ground so that the reinforcing members are located within the slab or sheet of concrete or concrete like material. Accordingly, a height and size of the block or Dobie 2800 can vary depending on the nature and type of concrete or concrete slab being poured.

FIG. 23 is another perspective view of a block or Dobie 2900 for joining reinforcing members in accordance with another exemplary embodiment. The block or Dobie 2900 as shown in FIG. 23 includes a generally rectangular block 2910, and two openings 2920, 2930, which are configured to receive a reinforcing member 400. Each of the openings 2920, 2930 includes a pair of angled walls 2922, 2924, 2932, 2934 and a base member 2926, 2936. The openings 2920, 2930 extends from a front portion to a back portion of the block 2810, and a side portion to a side portion of the block, respectively. Thus, the two openings 2920, 2930 are perpendicular to one another. In accordance with an alternative embodiment, the two pairs of angled walls 2922, 2924, 2932, 2934 can intersect one another such that the base member 2926, 2936 is not present within the block. In accordance with an exemplary embodiment, the two pairs of angled walls 2922, 2924, 2932, 2934 are configured to receive a plurality of different sizes of reinforcing members or rebar 400, 500. In addition, rather than two pair of angled walls 2922, 2924, 2932, 2934 in a V shape, one or both of the walls can be vertical or any other shape, which extend downward to the base members 2926,2936, which are configured to support a lower portion of a reinforcing member 400, 500. In addition, the base members 2926, 2936 can be at different heights to correspond to an upper and a lower reinforcing member 400, 500, respectively.

The block or dobie 2900 is configured to lift or raise the connected reinforcing members off the surface or ground so that the reinforcing members are located within the slab or sheet of concrete or concrete like material. Accordingly, a height and/or size of the block or Dobie 2900 will vary depending on the nature and type of concrete or concrete slab being poured. In addition, although the block or Dobie 2800, 2900 are described as generally rectangular, the blocks or Dobies can be cylindrical and the like without departing from the present disclosure.

FIG. 24 is a top view of a plurality of reinforcing members 400, 500 with a plurality of blocks or Dobies 2900, which form a grid 3000 in accordance with an exemplary embodiment. As shown in FIG. 24, the reinforcing members 400, 500 are lifted or positioned above the ground using one or more blocks or Dobies 2800. Depending on the size of the reinforcing members 400, 500, each and every one of the reinforcing members 400, 500 at or near the portion, which the members 400, 500 cross one another can be positioned within a block or Dobie 2900, or alternatively, a combination of blocks or Dobies 2800, 2900 as shown in FIGS. 22 and 23 can be used in conjunction with one or more clips 1000, 1500, 1600, 1700, 1900, 2100, 2300, 2400, 2500 as shown in FIGS. 1-21, 25, and 26. In accordance with an exemplary embodiment, a plurality of blocks and/or Dobies can be used to assist with laying out the grid 3000, which can improve the time spent in laying out the grid 3000.

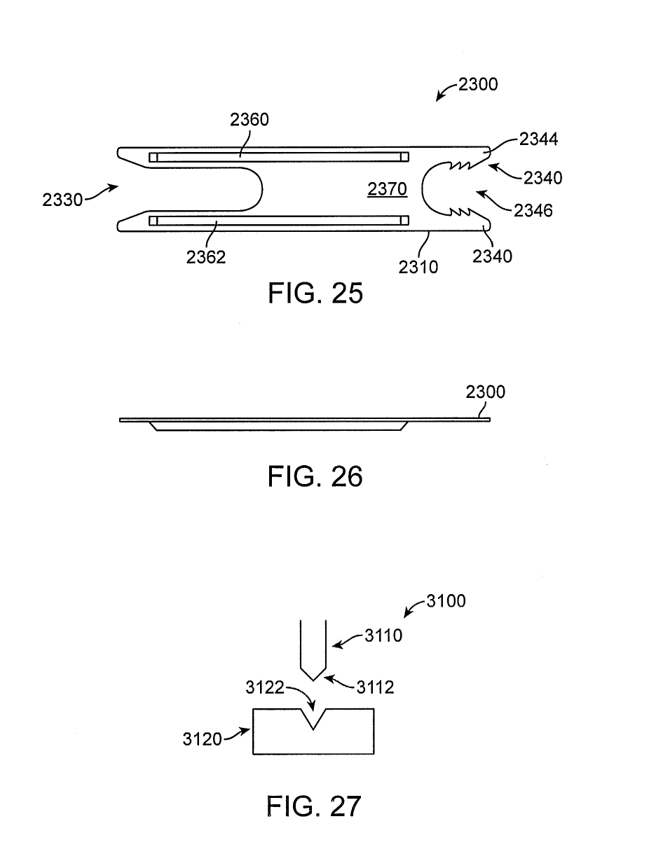

FIG. 25 is a top view of a clip for joining reinforcing members for use in concrete slabs and/or column having a pair of stiffening ribs in accordance with an exemplary embodiment. As shown in FIG. 25, the clip 2300 is from a strip of clips 2200 for joining reinforcing members for use in reinforced concrete slabs and/or columns as shown in FIG. 16. As shown in FIG. 25, the clip 2300 has not been shaped into a clip. Rather the clip 2300 is relatively flat, which can be stored and/or shipped in a strip and a plurality of clips, which have not placed into a die or pressed into a three-dimensional shape. The clip 2300 includes a first pair of legs 2330, a mid-portion 2310, and a proximal portion or second pair of legs 2320. Each of the legs 2312, 2314 of the first pair of legs 2330 has a portion having a curvature thereto and adapted to wrap around a lower surface 402 of a first reinforcing member 400. Each of the legs 2342, 2344 of the second pair of legs 2340 has an inner surface adapted to exert a force against at least a portion of a side surface 502 of a second reinforcing member 500, the second reinforcing member 500 residing perpendicular to the first reinforcing member 400.

As shown in FIG. 25, the clip 2300 has a pair of stiffening ribs 2360, 2362, which extend longitudinally or lengthwise along an outer edge on an upper surface 2370 of the clip 2300 before forming. The pair of stiffening ribs 2360, 2362 allow for lighter metals to be used in forming the clip 2300, which still maintaining the required strength for larger rebar and the like. In accordance with an exemplary embodiment, the stiffening ribs 2360, 2362 extend from the first pair of legs 2330 towards the second pair of legs 2340. The stiffening ribs 2360, 2362 preferably have a V-shape cross-section. However, other shapes such as rectangular, oval or round, etc. can be used.

FIG. 26 is a cross-sectional view of a clip 2300 for joining reinforcing members for use in concrete slabs and/or column having a pair of stiffening ribs in accordance with an exemplary embodiment. As shown in FIG. 26, the stiffening ribs have a V-shaped cross-section. In accordance with an exemplary embodiment, the pair of stiffening ribs 2360, 2362 can be slightly offset relative to one another. In addition, the size, length and shapes of the stiffening ribs 2360, 2362 can vary depending on the metal and desired size of rebar.

FIG. 27 is a side view of a stamping die 3100 for stamping the pair of stiffening ribs 2360, 2362 as shown in FIGS. 25 and 26 in one or more clips. The stamping die 3100 includes a punch 3110 having a v-shaped tip 3112 and a die piece 3120 having a v-shaped groove 3122 therein. The size of the punch 3110, tip 3112 and the groove 3122 can vary depending on the size, shape, and depth of the stiffening ribs 2360, 2362.

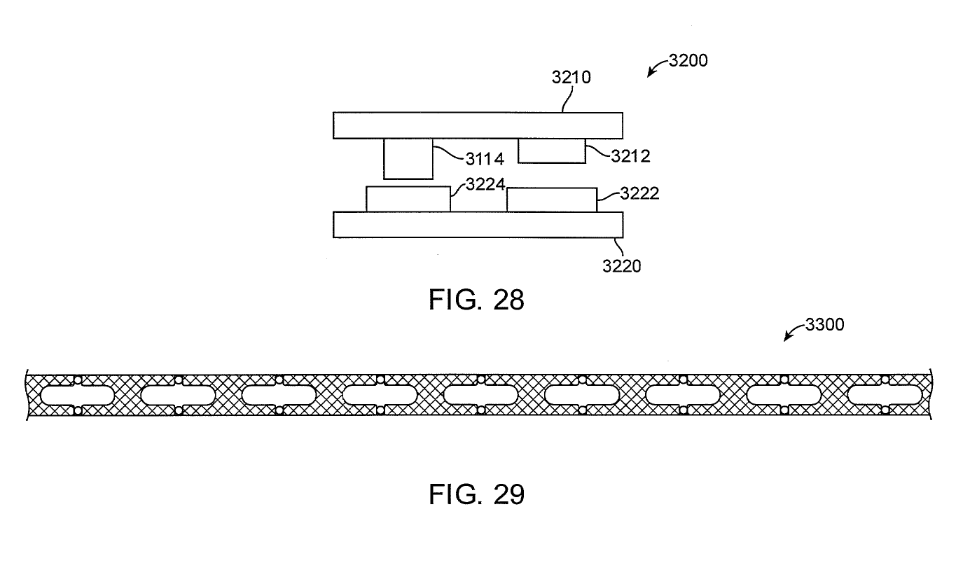

FIG. 28 is a side view of a die 3200 for stamping clips from a strip. The die 3200 includes an upper plate 3210 and a lower plate 3220. Each of the upper and the lower plates includes a pair of stamps 3212, 3214, 3222, 3224, which include one or more sharp edges for separating the clips 2300 from a strip of clips 3300 (FIG. 29).

FIG. 29 is strip of clips 3300 before stamping by the die as shown in FIG. 28. As shown in FIG. 29, the strips of clips 3300 are preferably stamped flat before forming and cutting. The strips of clips 3300 are fed into the die 3200 and stamped into a plurality of individual clips 2300, which are formed as described herein.

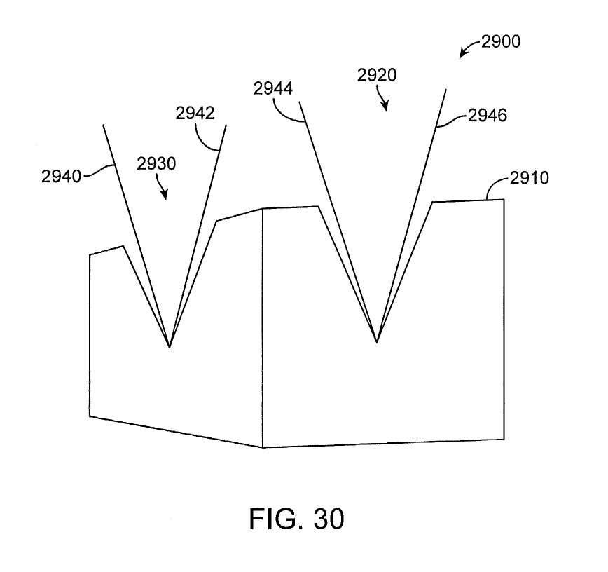

FIG. 30 is a perspective view of a block or Dobie 2900 for joining reinforcing members in accordance with an exemplary embodiment. As shown in FIGS. 23 and 30, the block or Dobie 2900 includes a generally rectangular block 2910, and two openings 2920, 2930, which are configured to receive a reinforcing member 400. Each of the openings 2920, 2930 includes a pair of angled walls 2922, 2924, 2932, 2934 and a base member 2926, 2936. The openings 2920, 2930 extends from a front portion to a back portion of the block 2910, and a side portion to a side portion of the block, respectively. Thus, the two openings 2920, 2930 are perpendicular to one another. In accordance with an alternative embodiment, the two pairs of angled walls 2922, 2924, 2932, 2934 can intersect one another such that the base member 2926, 2936 is not present within the block. In accordance with an exemplary embodiment, the two pairs of angled walls 2922, 2924, 2932, 2934 are configured to receive a plurality of different sizes of reinforcing members or rebar 400, 500. In addition, rather than two pair of angled walls 2922, 2924, 2932, 2934 in a V shape, one or both of the walls can be vertical or any other shape, which extend downward to the base members 2926,2936, which are configured to support a lower portion of a reinforcing member 400, 500. In addition, the base members 2926, 2936 can be at different heights to correspond to an upper and a lower reinforcing member 400, 500, respectively.

In accordance with an exemplary embodiment, as shown in FIG. 30, each of the openings 2920, 2930 extends from a front portion to a back portion of the block 2910, and a side portion to a side portion of the block, respectively and has a pair of wires 2940, 2942, 2944, 2946, which extend upward from the base of the openings 2920, 2930 and are configured to wrap around a piece of rebar. As shown, the pair of wires 2940, 2942, 2944, 2946 can be tied around the rebar as desired. In accordance with another embodiment, a pair of wires can extend from a base of a single Dobie 2800 as shown in FIG. 22.

It will be understood that the foregoing description is of the preferred embodiments, and is, therefore, merely representative of the system and methods of use of the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A plurality of clips for joining reinforcing members comprising:
at least two clips, each of the at least two clips comprising:
a first pair of legs, each of the legs of the first pair of legs having a portion having a curvature thereto and adapted to wrap around a lower surface of a first reinforcing member;
a second pair of legs, each of the legs of the second pair of legs having an inner surface adapted to exert a force against at least a portion of a side surface of a second reinforcing member, the second reinforcing member residing perpendicular to the first reinforcing member; and
a mid-portion, which connects the first pair of legs to the second pair of legs; and
a breakable connector positioned between the at least two clips, wherein the breakable connector attaches a pair of clips to one another, and upon a force thereto, the breakable connector separates the at least two clips from one another.

2. The clips of claim 1, wherein each of the second pair of legs includes an inner portion and an outer portion thereto, and wherein the inner portions of the second pair of legs are adapted to wrap around the side surface of the second reinforcing member.

3. The clips of claim 2, wherein the second pair of legs comprises a partial inner loop, which fits around the side surface of the second reinforcing member.

4. The clips of claim 2, wherein the second pair of legs comprises a pair of outer partial loops, which extend downward, and an inner partial loop, which extends upward.

5. The clips of claim 4, wherein the outer partial loops are U-shaped, and the inner partial loop is U-shaped, the outer partial loops facing an opposite direction of the inner partial loop.

6. The clips of claim 1, wherein the mid-portion is formed by crossing the first pair of legs over one another, and each of the clips is formed from a single piece of wire.

7. The clips of claim 1, wherein the first pair of legs includes a hook portion, which extends outward from a mid-portion of each of the first pair of legs.

8. A clip for joining reinforcing members, comprising:
a first portion having a curvature thereto and adapted to wrap around a lower surface of a first reinforcing member;
a second portion having a curvature thereto and adapted to exert a force against a side surface of a second reinforcing member, the second reinforcing member residing perpendicular to the first reinforcing member; and
a mid-portion, which connects the first portion pair of legs to the second pair of legs.

9. The clip of claim 8, wherein the second portion has a series of teeth on an inner portion of the curvature thereto, which exerts a force against the side surface upon placing the second portion adjacent to the side surface of the second reinforcing member.

10. The clip of claim 8, wherein the mid-portion is a solid plate, which extends from the first portion to the second portion.

11. The clip of claim 10, wherein the mid-portion has an opening therein, which is configured to receive a rod upon which one or more clips can be attached.

12. The clip of claim 8, wherein the clip is stamped from a sheet of material and formed on a mandrel, in a press and die tooling device.

13. The clip of claim 8, wherein the clip has a pair of stiffening ribs, which extend along an outer edge of the clip.

14. A method of forming a plurality of clips for joining reinforcing members comprising:
cutting one or more clips from a sheet of material,
forming each of the one or more clips to have a first portion having a curvature thereto and adapted to wrap around a lower surface of a first reinforcing member, a second portion having a curvature thereto and adapted to exert a force against a side surface of a second reinforcing member, the second reinforcing member residing perpendicular to the first reinforcing member, and a mid-portion, which connects the first portion pair of legs to the second pair of legs.

15. The method of claim 14, wherein the second portion has a series of teeth on an inner portion of the curvature thereto, which exerts a force against the side surface upon placing the second portion adjacent to the side surface of the second reinforcing member.

16. The method of claim 15, wherein the mid-portion is a solid plate, which extends from the first portion to the second portion.

17. The method of claim 16, wherein the mid-portion has an opening therein, which is configured to receive a rod upon which one or more clips can be attached.

18. The method of claim 14, wherein the sheet of material is a sheet of sheet metal, and bending the cut clips on a metal forming device.

19. The method of claim 14, wherein each of the plurality of clips is formed from a strip of the sheet metal by:
stamping out one or more openings within the strip of sheet metal;
separating the strip of sheet metal into one or more clips;
placing the one or more clips onto a die forming tool or press; and
forming the one or more clips into a three-dimension clip.

20. A clip for joining reinforcing members comprising:
a first member having a cavity therein with an open end;
a second member having a cavity therein with an open end;
a handle, which extends outward from the first and/or second member; and
wherein the first and second members are fixed to one another so that each of the open ends face in opposite directions, and the first and second members are perpendicular to one another.
